(19) United States
(12) Patent Application Publication
(10) Pub. No.: US 2024/0370318 A1
(43) Pub. Date: Nov. 7, 2024

(54) Agentless Initiation of Host Operating System Actions from a Baseboard Management Controller

(71) Applicant: Dell Products L.P., Round Rock, TX (US)

(72) Inventor: Charles Emmanuel ROSE, Georgetown, TX (US)

(73) Assignee: Dell Products L.P., Round Rock, TX (US)

(21) Appl. No.: 18/312,590

(22) Filed: May 4, 2023

(51) Int. Cl. G06F 9/54; G06F 9/50; G06F 13/42

(52) U.S. Cl. CPC G06F 9/542; G06F 9/5077; G06F 13/4282; G06F 2213/0042

(57) ABSTRACT

Disclosed methods utilize existing OS infrastructure to act as a low speed interface that a BMC can access and invoke to trigger operating system actions, thereby eliminating the need for a proprietary host agent. Disclosed features include light weight, scripted user-space utilities that utilize existing kernel infrastructure to trigger user space actions based on system hardware changes. Such utilities may be included within popular Linux distributions to reduce software management costs for OEMs, eliminate delays in new code inclusion, block dependencies, and provide customers with one source for all operating system software packages.

### TECHNICAL FIELD

The present disclosure pertains to information handling systems and, more particularly, systems featuring an out-of-band management controller such as a baseboard management controller (BMC).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems, including many rack mount and other types of server class systems, may be provisioned with a baseboard management controller (BMC) to facilitate remote system management. An illustrative brand of BMC is the integrated Dell remote access controller (iDRAC) family of BMCs from Dell Technologies.

In some situations, it may be necessary or desirable to initiate an OS action from or by the BMC. Typically, however, initiating operating system actions via a BMC requires agent software, running on the host operating system (OS), that employs some form of polling mechanism to enable the host OS to receive commands from the BMC, execute them, and return results back to the BMC. Development of such agent software is generally time consuming and complex and long term maintenance of agent software is difficult. In addition, for a open source host OS such as Linux, the use of agent software constitute or required the use of proprietary software on the host, which adds to the overheads for original equipment manufacturer (OEMs), distributors, and customers.

### SUMMARY

Subject matter included herein discloses a method to utilize existing OS infrastructure to act as a low speed interface that a BMC can access and invoke to trigger operating system actions thereby eliminating the need for a proprietary host agent in most cases.

Subject matter included herein discloses light weight, scripted user-space utilities that utilize existing kernel infrastructure to trigger user space actions based on system hardware changes. Such utilities may be scripted and released with a compatible Open Source license to encourage inclusion within popular Linux distributions and thereby reducing software management costs for OEMs, and eliminating delays in new code inclusion and block dependencies and providing customers with one source to get all their operating system software packages.

In one aspect, disclosed methods include enabling, by a BMC of an information handling system, a virtual resource with a predetermined value for a configuration parameter of the virtual device. The BMC exposes the virtual resource to a host OS. The host OS is configured to respond to a detected event by determining whether the detected event comprises a triggering event and, responsive to determining the detected event comprises a triggering event, executing an OS action associated with the predetermined value of the configuration parameter. In this manner, disclosed methods associate various OS actions with predetermined values of a configuration parameter and leverage existing OS infrastructure to enable a BMC to trigger OS actions “agentlessly” i.e., with no background service dedicated to the applicable OS action, thereby conserving CPU cycles. In addition, disclosed methods beneficially do not require the host OS to poll the BMC. All required logic for implementing desired OS actions can be implemented in user space program files. In some cases, the program files may simply specify an OS-executable script. If the device disconnects prematurely, recovery can be easily handled. In addition, the program file specifying the desired host OS action may contain a signal to the BMC, e.g., via a Keyboard Controller Style (KCS) interface of an Intelligent Platform Management Interface (IPMI), to terminate the virtual resource session and thereby complete the transaction.

In at least some embodiments, a detection daemon running in a user space of the host OS is configured to determine whether detected events constitute triggering events that can invoke OS action. The detection daemon may determine whether a detected event satisfies any of one or more rules, each of which may define one or more matching criteria and associate the matching criteria with a host OS action definition. The host OS action definition may specify a program file and a host OS action, and may include the configuration parameter of the virtual resource as an attribute of OS action. The matching criteria may specify matching values for any one or more of: an action type of the detected event (e.g., an add action), a subsystem type of the virtual resource, e.g., a USB subsystem, a vendor identifier indicative of vendor of the baseboard management controller, and a model identifier indicative of a model of the baseboard management controller.

The virtual resource may a virtual Universal Serial Bus (USB) device such as a virtual USB block storage device, a virtual USB network interface controller (NIC), or another suitable type of USB device. The configuration parameter may include or consist of all or a portion of a serial number for the virtual resource, which may be programmed or otherwise assigned by the BMC.

In at least some embodiments including embodiments featuring a Linux host OS, determining that the detected event constitutes a triggering event may include passing the detected event to a user space of the host OS wherein a detection daemon running in the host OS user space is configured to determine whether the detected event satisfies any of one or more rules specifying criteria for metadata associated with the detected event. These rules may be stored, for example, in a udev directory of a Linux OS deployment.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary information handling system;

FIG. 2 is a sequence diagram illustrating an agentless initiation of a host OS action by a BMC; and

FIG. 3 is a flow diagram of a method for initiating a host OS action.

### DETAILED DESCRIPTION

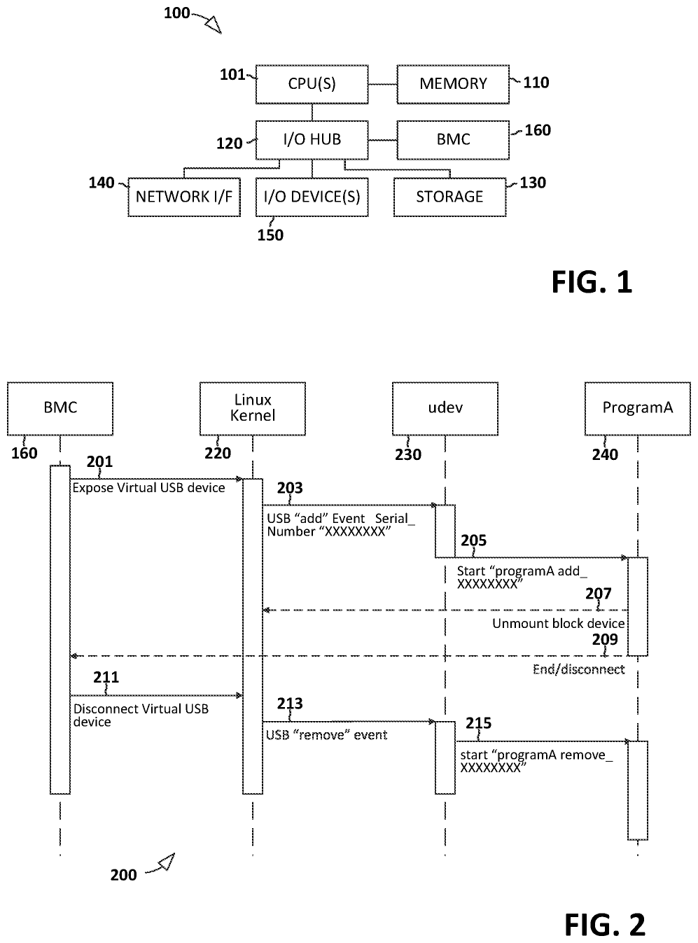

Exemplary embodiments and their advantages are best understood by reference to FIGS. 1-3, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

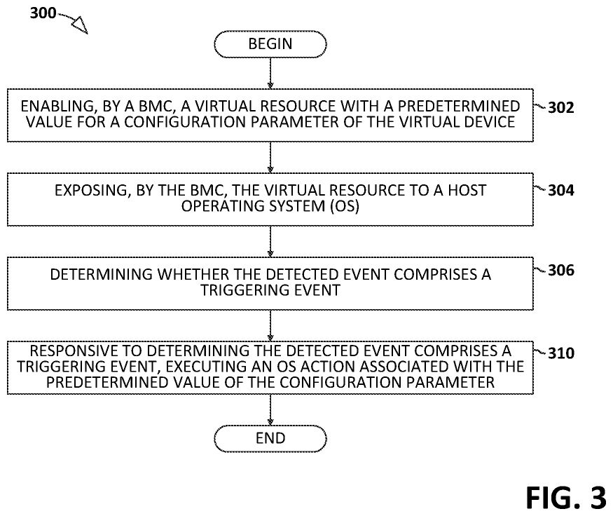

Referring now to FIG. 1, an exemplary information handling system 100 suitable for use in conjunction with agentless initiation of host OS actions illustrated in FIG. 2 and FIG. 3 is depicted. The information handling system 100 illustrated in FIG. 1 includes one or more general purpose processors or central processing units (CPUs) 101 communicatively coupled to a memory resource 110 and to an input/output hub 120 to which various I/O resources and/or components are communicatively coupled. The I/O resources explicitly depicted in FIG. 1 include a network interface 140, commonly referred to as a NIC (network interface card), storage resources 130, and additional I/O devices, components, or resources 150 including as non-limiting examples, keyboards, mice, displays, printers, speakers, microphones, etc. The illustrated information handling system 100 includes a baseboard management controller (BMC) 160 providing, among other features and services, an out-of-band management resource which may be coupled to a management server (not depicted). In at least some embodiments, BMC 160 may manage information handling system 100 even when information handling system 100 is powered off or powered to a standby state. BMC 160 may include a processor, memory, an out-of-band network interface separate from and physically isolated from an in-band network interface of information handling system 100, and/or other embedded information handling resources. In certain embodiments, BMC 160 may include or may be an integral part of a remote access controller (e.g., a Dell Remote Access Controller or Integrated Dell Remote Access Controller) or a chassis management controller.

The following description disclosed leveraging existing OS infrastructure in combination with a serial number of another suitable configuration parameter for a virtual USB device as a mechanism to encode command requests from the BMC that can be used by the host OS to perform an appropriate action (e.g. calling a program). These features are illustrated herein in the context of a Linux OS and event subsystem /udev. It is understood however, that other implementations are encompassed by the disclosed examples.

The /udev subsystem of a Linux OS includes a /udev daemon that receives events generated by the Linux kernel based on system hardware changes, including, as an example, the appearance of a USB device. Rules can be developed to define what programs can be run based on hardware events. With this infrastructure mechanism, it is possible to write rules that detect the addition of a USB device and initiate an appropriate OS program with the device's serial number as a program parameter or attribute.

The following sets forth example code:

Example 1:
/ etc/udev/ru les.d/99-usb. rules
ACTION==“add”, SUBSYSTEMS==“usb”,
ENV{ID_MODEL_ID}==“0003”,
ENV{ID_ VENDOR_ID}==“413c”,
RUN+=“/usr/bin/programA add $env{ID_SERIAL_SHORT}”
ACTION==“remove”, SUBSYSTEMS==“usb”,
ENV{ID_MODEL_ID}==“0003”,
ENV{ID_VENDOR_ID}==“413c”,
RUN+=“/usr/bin/programA remove $env{ID_SERIAL_SHORT}”

Example 1 describes a “udev” rule on the Linux host OS. With this rule, the host OS would wait for an “add” event for a USB device with MODEL ID=0003 and VENDOR_ID=413c (e.g., predefined and guaranteed an specific OEM BMC iDRAC). When a matching event is found (that is, when an identified BMC activates the virtual USB device), the udev daemon would execute the program “/usr/bin/program” with the device's serial number as the attribute. In example 1, this would be:
“/usr/bin/program add 1028_ 123456”

A similar event occurs when the device is removed and can trigger the system to run “/usr/bin/program remove
1028_ 123456”.

Turning now to FIG. 2, a sequence diagram 200 illustrates an exemplary solution for agentless initiation of OS actions from a BMC. For the sake of clarity and illustration, the solution 200 depicted in FIG. 2 illustrates an implementation in which the host OS is a Linux OS and the virtual resource fabricated by the BMC to trigger the solution is a virtual USB device. Those of ordinary skill will appreciate that the depicted example is not exhaustive of all possible implementations of disclosed solutions and that other implementations may, for example, fabricate a different type of virtual resource.

The solution depicted in FIG. 2 involves BMC 160, a Linux kernel 220, an event subsystem of the Linux kernel referred to in FIG. 2 as /udev 230, and a user defined program, identified as “ProgramA” 240. In accordance with the disclosed solution, BMC 160 exposes (201) a virtual USB device, which BMC 160 has programmed with a predetermined value such “XXXXXXXX” for the device's serial number or another suitable configuration parameter of the virtual resource.

Linux kernel 220 detects the virtual USB device and sends (203) a USB “add” event indicating the predetermined serial number value to /udev 230, which, upon confirming that the USB add event satisfies a criteria specified in a /udev rule, executes a host OS action defined within the /udev rule. For the example depicted in FIG. 2, the applicable /udev rule results in a host OS action (205) to Start “ProgramA add XXXXXXXX.” In this manner, the serial number programmed into the virtual USB device is included as an attribute in the OS action triggered when the BMC exposes the virtual USB device to the Linux OS. ProgramA may contain a simple script or more complex logic or functionality.

FIG. 2 further illustrates ProgramA 240 concluding by sending an unmount block device message (207) to Linux kernel 220 and/or sending an end/disconnect message (209) to BMC 160. The solution 200 depicted in FIG. 2 further includes BMC 160 passing a disconnect virtual USB device message (211) to Linux kernel 220, which then passes a USB “remove” event message 213 to /udev 230, causing /udev to execute (215) a start “ProgramA remove XXXXXXXX” command.

Referring now to FIG. 3, a flow diagram illustrates an information handling system method 300 for agentless initiation of host OS actions from an out-of-band management resource such as a BMC or the like. The method 300 illustrated in FIG. 3 includes BMC operations and operations associated with the host OS and an event handling subsystem of the host OS. As depicted in FIG. 3, the BMC enables (operation 302) a virtual resource, e.g., a virtual USB device, with a predetermined value for a configuration parameter of the virtual resource, e.g., a serial number of the virtual resource. The BMC may then expose (operation 304) the virtual resource to the host OS, e.g., a Linux OS. As indicated in the preceding description of FIG. 2, the host OS may be configured to recognize the exposing of the virtual resource as a detected event determining (operation 306) whether the detected event comprises a triggering event, e.g., by invoking an event subsystem to determine whether the detected event satisfies any rule-defined criteria. If the detected event is determined to be a triggering event, the illustrated method includes executing (operation 310) an OS action associated with the predetermined value of the configuration parameter.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
enabling, by a baseboard management controller (BMC) of an information handling system, a virtual resource with a predetermined value for a configuration parameter of the virtual device; and
exposing, by the BMC, the virtual resource to a host operating system (OS) configured to respond to a detected event by:
determining whether the detected event comprises a triggering event; and
responsive to determining the detected event comprises a triggering event, executing an OS action associated with the predetermined value of the configuration parameter.

2. The method of claim 1, wherein a detection daemon running in a user space of the host OS is configured to determine whether the detected event comprises a triggering event.

3. The method of claim 2, wherein the detection daemon determines whether the detected event satisfies any of one or more rules, wherein each rule defines one or more matching criteria and associates the matching criteria with a host OS action definition.

4. The method of claim 3, wherein the matching criteria specify matching values any one or more of:
an action type of the detected event;
a subsystem type of the virtual resource;
a vendor identifier indicative of vendor of the baseboard management controller; and
a model identifier indicative of a model of the baseboard management controller.

5. The method of claim 3, wherein the host OS action definition includes the predetermined value of the configuration parameter as an attribute of the host OS action.

6. The method of claim 1, wherein the virtual resource comprises a virtual Universal Serial Bus (USB) device.

7. The method of claim 6, wherein the virtual USB device is selected from:
a virtual USB block storage device; and
a virtual USB network interface controller (NIC);

8. The method of claim 1, wherein the configuration parameter comprises a serial number for the virtual resource.

9. The method of claim 1, wherein determining that the detected event comprises a triggering event includes passing the detected event to a user space of the host OS wherein a detection daemon running in the user space is configured to determine whether the detected event satisfies any of one or more rules specifying criteria for metadata associated with the detected event.

10. The method of claim 1, wherein the host OS action comprises a script executable by the host OS.

11. An information handling system, comprising:
a central processing unit (CPU);
a system memory, accessible to the CPU;
a baseboard management controller (BMC) communicatively coupled to the CPU;
processor executable instructions, stored in a non-transitory computer readable medium of the information handling system, that when executed by a processor of the information handling system, cause the system to perform operations including:
enabling, by a baseboard management controller (BMC) of an information handling system, a virtual resource with a predetermined value for a configuration parameter of the virtual device; and
exposing, by the BMC, the virtual resource to a host operating system (OS) configured to respond to a detected event by:
determining whether the detected event comprises a triggering event; and
responsive to determining the detected event comprises a triggering event, executing an OS action associated with the predetermined value of the configuration parameter.

12. The information handling system of claim 11, wherein a detection daemon running in a user space of the host OS is configured to determine whether the detected event comprises a triggering event.

13. The information handling system of claim 12, wherein the detection daemon determines whether the detected event satisfies any of one or more rules, wherein each rule defines one or more matching criteria and associates the matching criteria with a host OS action definition.

14. The information handling system of claim 13, wherein the matching criteria specify matching values any one or more of:
an action type of the detected event;
a subsystem type of the virtual resource;
a vendor identifier indicative of vendor of the baseboard management controller; and
a model identifier indicative of a model of the baseboard management controller.

15. The information handling system of claim 13, wherein the host OS action definition includes the predetermined value of the configuration parameter as an attribute of the host OS action.

16. The information handling system of claim 11, wherein the virtual resource comprises a virtual Universal Serial Bus (USB) device.

17. The information handling system of claim 16, wherein the virtual USB device is selected from:
a virtual USB block storage device; and
a virtual USB network interface controller (NIC);

18. The information handling system of claim 11, wherein the configuration parameter comprises a serial number for the virtual resource.

19. The information handling system of claim 11, wherein determining that the detected event comprises a triggering event includes passing the detected event to a user space of the host OS wherein a detection daemon running in the user space is configured to determine whether the detected event satisfies any of one or more rules specifying criteria for metadata associated with the detected event.

20. The information handling system of claim 11, wherein the host OS action comprises a script executable by the host OS.
